(19) United States
(12) Patent Application Publication
(10) Pub. No.: US 2014/0343929 A1
(43) Pub. Date: Nov. 20, 2014

(54) VOICE RECORDING SYSTEM AND METHOD

(71) Applicant: HON HAI PRECISION INDUSTRY CO., LTD., New Taipei (TW)

(72) Inventor: CHE-CHAUN LIANG, New Taipei (TW)

(73) Assignee: HON HAI PRECISION INDUSTRY CO., LTD., New Taipei (TW)

(21) Appl. No.: 14/074,224

(22) Filed: Nov. 7, 2013

(30) Foreign Application Priority Data
May 14, 2013 (TW) 102116969

(51) Int. Cl. G10L 25/48

(52) U.S. Cl. CPC G10L 25/48
USPC 704/201

(57) ABSTRACT

An electronic device includes a camera and two microphones. The space in front of the camera is divided into a plurality of imaginary cubic areas. Each imaginary cubic area is associated with a delay parameter. The camera locates a face of a user and determines an imaginary cubic area in which the face is located from the plurality of imaginary cubic areas. A wave beam pointing to the imaginary cubic area is calculated according to the delay parameter associated with the imaginary cubic area. The two microphone record voices within a range of the wave beam. A voice recording method is also provided.

### REFERENCE TO RELATED APPLICATIONS

This application claims all benefits accruing under 35 U.S.C. §119 from Taiwan Patent Application No. 102116969, filed on May 14, 2013 in the Taiwan Intellectual Property Office. The contents of the Taiwan Application are hereby incorporated by reference.

### BACKGROUND

1. Technical Field

The disclosure generally relates to voice processing technologies, and particularly relates to voice recording systems and methods.

2. Description of Related Art

More and more electronic devices, such as notebook computers, tablet computers, and smart phones, are designed to support voice recording functions. However, the voices recorded by these electronic devices don't have sufficient high quality to meet the requirements of high definition voices.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an exemplary embodiment of an electronic device suitable for implementing a voice recording system.

FIG. 2 is a schematic view of an example of the electronic device of FIG. 1.

FIG. 3 is a block diagram of one embodiment of the voice recording system.

FIG. 4 is a schematic view of an example of divided imaginary cubic areas in front of the electronic device of FIG. 2.

FIG. 5 is a schematic view of an example of an imaginary cubic area and two microphones.

FIGS. 6 and 7 show a flowchart of one embodiment of a voice recording method in the electronic device shown in FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

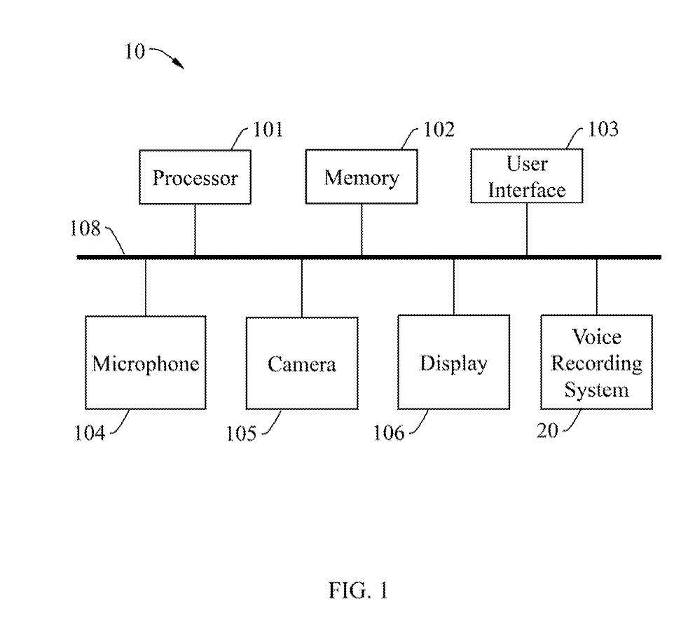

FIG. 1 is a block diagram of an exemplary embodiment of an electronic device 10 suitable for implementing a voice recording system 20. The illustrated embodiment of the electronic device i0 includes, without limitation: at least one processor 101, a suitable amount of memory 102, a user interface 103, two microphones 104, a camera 105, and a display 106. Of course, the electronic device 10 may include additional elements, components, modules, and functionality configured to support various features that are unrelated to the subject matter described here. In practice, the elements of the electronic device 10 may be coupled together via a bus or any suitable interconnection architecture 108.

The processor 101 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here.

The memory 102 may be realized as RAM memory, flash memory, EPROM memory, EEPROM memory, registers, a hard disk, a removable disk, a CD-ROM, or any other form of storage medium known in the art. The memory 102 is coupled to the processor 101 such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The user interface 103 may include or cooperate with various features to allow a user to interact with the electronic device 10. Accordingly, the user interface 103 may include various human-to-machine interfaces, e.g., a keypad, keys, a keyboard, buttons, switches, knobs, a touchpad, a joystick, a pointing device, a virtual writing tablet, a touch screen, or any device, component, or function that enables the user to select options, input information, or otherwise control the operation of the electronic device 10. In various embodiments, the user interface 103 may include one or more graphical user interface (GUI) control elements that enable a user to manipulate or otherwise interact with an application via the display 106.

The two microphones 104 may receive sound and convert the sound into electronic signals, which can be stored and processed in a computing device.

The camera 105 may records images. The images may be photographs or moving images such as videos or movies. The camera 105 may be used to detect a user in front and recognize the face of the user.

The display 106 is suitably configured to enable the electronic device 10 to render and display various screens, GUIs, GUI control elements, drop down menus, auto-fill fields, text entry fields, message fields, or the like. Of course, the display 106 may also be utilized for the display of other information during the operation of the electronic device 10, as is well understood.

The voice recording system 20 may be implemented using software, firmware, and computer programming technologies.

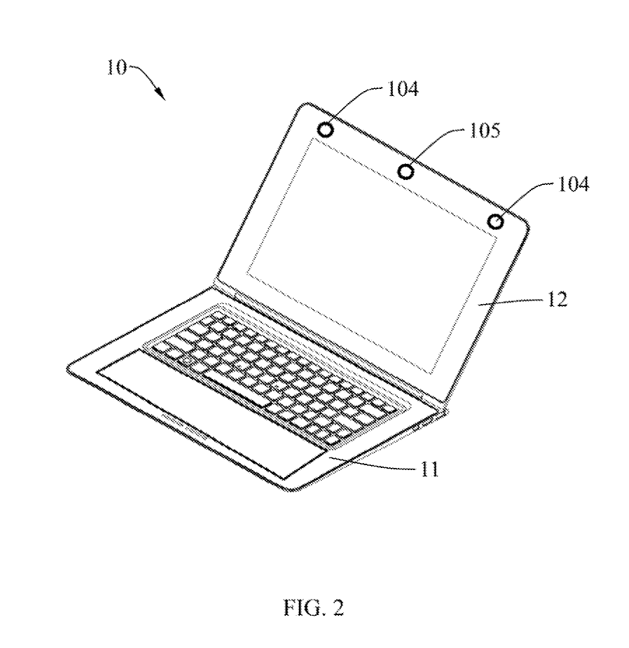

The electronic device 10 may be realized in any common form factor including, without limitation: a desktop computer, a mobile computer (e.g., a tablet computer, a laptop computer, or a netbook computer), a smartphone, a video game device, a digital media player, or the like. FIG. 2 shows an example of the electronic device 10, which is realized in a notebook. The electronic device 10 includes a base member 11 and a display member 12. The display member 12 is pivotally coupled to the base member 11. The two microphones 104 and the camera 105 are arranged in a line on the display member 12. The two microphones 104 are spaced and located on two sides of the camera 105.

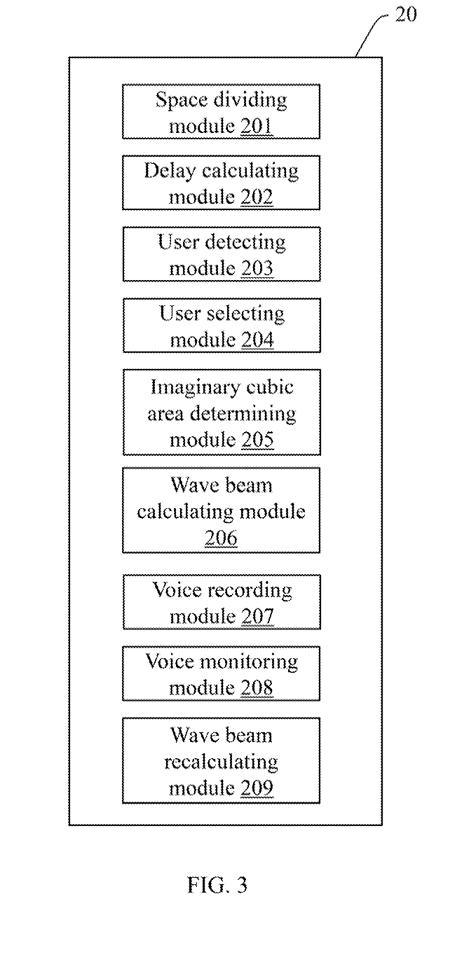

FIG. 3 shows a block diagram of an embodiment of the voice recording system 20 implemented in the electronic device 10. The voice recording system 20 includes a space dividing module 201, a delay calculating module 202, a user detecting module 203, a user selecting module 204, an imaginary cubic area determining module 205, a wave beam calculating module 206, a voice recording module 207, a voice monitoring module 208, and a wave beam recalculating module 209.

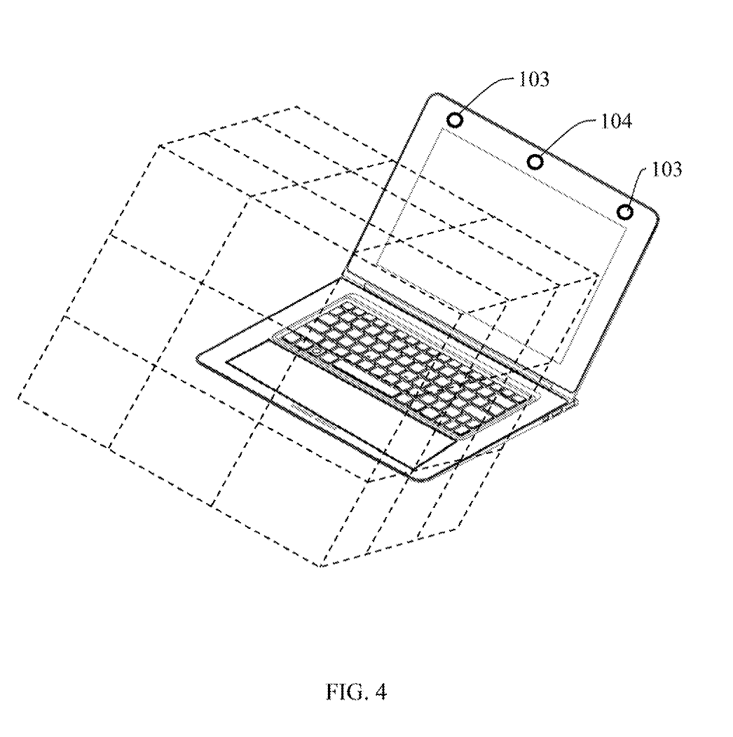

The space dividing module 201 divides the space in front of the camera 104 into a plurality of imaginary cubic areas. For example, the space in front of the camera 104 is divided into 27 (3 by 3 by 3) imaginary cubic areas as shown in FIG. 4.

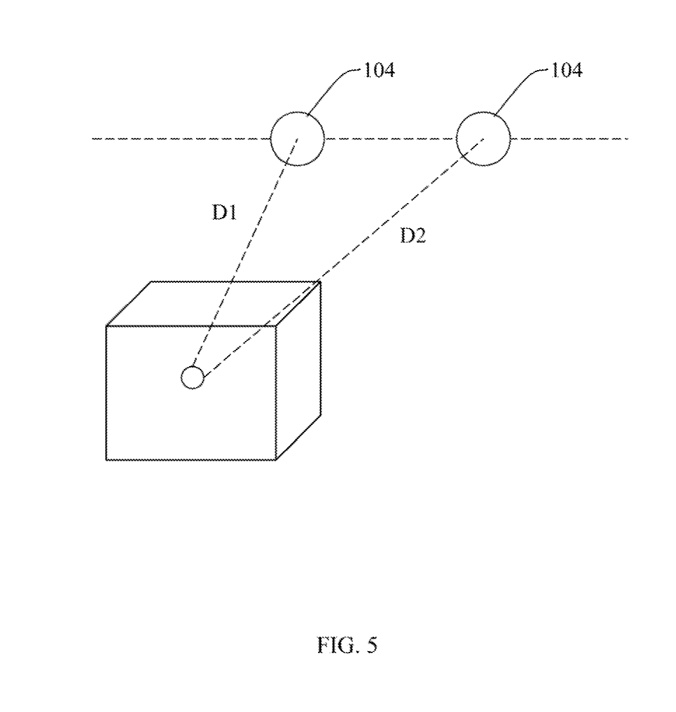

The delay calculating module 202 may calculate a delay parameter for each of the plurality of imaginary cubic areas and associate each imaginary cubic area with the corresponding delay parameter. A delay parameter represents a difference between time for sound to travel from an imaginary cubic area to one of the two microphones 104 and time for sound to travel from the imaginary cubic area to another one of the two microphones. As shown in FIG. 5, the delay calculating module 202 obtains a delay parameter for an imaginary cubic area according to the following formula:

$$Δ = \frac{\vert {D}_{1} - {D}_{2} \vert}{C} ,$$

where Δ is the delay parameter, D₁ is a distance between the imaginary cubic area and one of the two microphones 104, D₂ is a distance between the imaginary cubic area and another one of the two microphones 104, and C is the speed of sound.

The user detecting module 203 may instruct the camera 105 to detect whether multiple users appear in front of the camera 105.

When multiple users are detected in front of the camera 105, the user selecting module 204 may recognize mouth gestures of each of the multiple users and select a user whose mouth gestures are the most tremendous among the multiple users.

The imaginary cubic area determining module 205 may instruct the camera 105 to locate the face of the selected user and determine an imaginary cubic area in which the face is located among from the plurality of imaginary cubic areas.

The wave beam calculating module 206 may calculate a wave beam pointing to the imaginary cubic area according to the delay parameter associated with the imaginary cubic area.

The voice recording module 207 may instruct the two microphones 104 to record voices inside the range of the wave beam and suppress noises outside of the range of the wave beam.

The voice monitoring module 208 may monitor whether a difference between voices recorded by the two microphones 104 exceeds a predetermined threshold.

When the difference between voices recorded by the two microphones 104 exceeds the predetermined threshold, the wave beam recalculating module 209 may recalculate the wave beam pointing to the imaginary cubic area by applying a particle swarm optimization (PSO) algorithm.

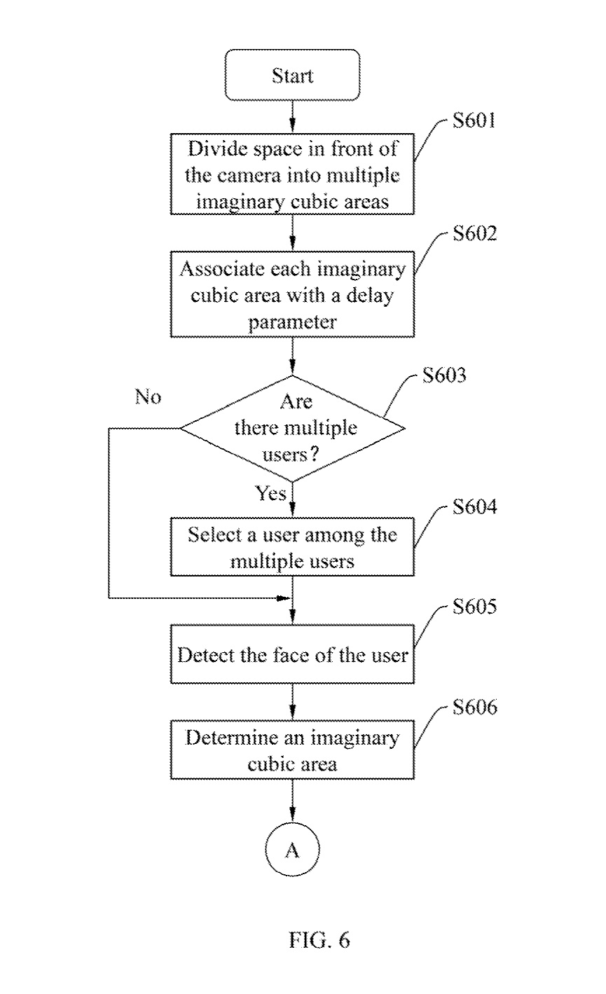

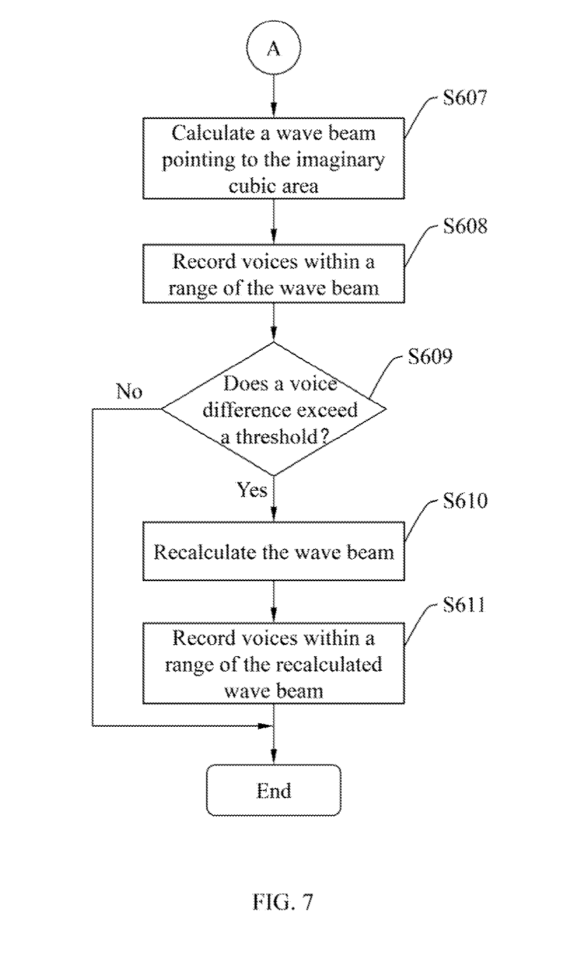

FIGS. 6 and 7 show a flowchart of one embodiment of a voice recording method implemented in the electronic device 10. The method includes the following steps.

In step S601, the space dividing module 201 divides the space in front of the camera 104 into a plurality of imaginary cubic areas.

In step S602, the delay calculating module 202 calculates a delay parameter for each of the plurality of imaginary cubic areas and associates each imaginary cubic area with the corresponding delay parameter.

In step S603, the user detecting module 203 instructs the camera 105 to detect whether multiple users appear in front of the camera 105. If multiple users are detected in front of the camera 105, the flow proceeds to step S604, otherwise, the flow proceeds to step S605.

In step S604, the user selecting module 204 recognizes mouth gestures of each users and selects a user whose mouth gestures are the most tremendous among the users.

In step S605, the imaginary cubic area determining module 205 instructs the camera 105 to locate the face of the selected user.

In step S606, the imaginary cubic area determining module 205 determines an imaginary cubic area in which the face is located among from the plurality of imaginary cubic areas.

In step S607, the wave beam calculating module 206 calculates a wave beam pointing to the imaginary cubic area according to the delay parameter associated with the imaginary cubic area.

In step S608, the voice recording module 207 instructs the two microphones 104 to record voices within a range of the wave beam and to suppress noises outside of the range of the wave beam.

In step S609, the voice monitoring module 208 monitors whether a difference between voices recorded by the two microphones 104 exceeds a predetermined threshold. If the difference between voices recorded by the two microphones 104 exceeds the predetermined threshold, the flow proceeds to step S610, otherwise, the flow ends.

In step S610, the wave beam recalculating module 209 recalculates the wave beam pointing to the imaginary cubic area by applying a PSO algorithm.

In step S611, the voice recording module 207 instructs the two microphones 104 to record voices inside the range of the recalculated wave beam.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An electronic device comprising:
a camera;
two microphones;
a memory;
at least one processor coupled to the memory;
one or more programs being stored in the memory and executable by the at least one processor, the one or more programs comprising:
a space dividing module configured for imaginarily dividing imaginary space in front of the camera into a plurality of imaginary cubic areas;
a delay calculating module configured for associating each of the plurality of imaginary cubic areas with a delay parameter, the delay parameter representing a difference between time for sound to travel from an imaginary cubic area of the plurality of imaginary cubic areas to one of the two microphones and time for sound to travel from the imaginary cubic area to another one of the two microphones.
a cubic area determining module configured for instructing the camera to locate a face of a user and determining an imaginary cubic area in which the face is located from the plurality of imaginary cubic areas;
a wave calculating module configured for calculating a wave beam pointing to the imaginary cubic area according to the delay parameter associated with the imaginary cubic area; and
a voice recording module configured for instructing the two microphones to record voices within a range of the wave beam.

2. The electronic device of claim 1, wherein the voice recording module is further configured for suppressing noises outside the range of the wave beam.

3. The electronic device of claim 1, wherein the delay calculating module is configured for obtaining a delay parameter for each of the plurality of imaginary cubic areas according to the following formula:
$$Δ = \frac{\vert {D}_{1} - {D}_{2} \vert}{C} ,$$
wherein
Δ is the delay parameter,
D₁ is a distance between an imaginary cubic area of the plurality of imaginary cubic areas and one of the two microphones,
D₂ is a distance between the imaginary cubic area and another one of the two microphones, and
C is the speed of sound.

4. The electronic device of claim 3, further comprising:
a voice monitoring module configured for monitoring whether a difference between voices recorded by the two microphones exceeds a predetermined threshold, and
a wave beam recalculating module configured for recalculating the wave beam pointing to the imaginary cubic area by applying a particle swarm optimization (PSO) algorithm when the difference between voices recorded by the two microphones exceeds the predetermined threshold.

5. The electronic device of claim 3, further comprising:
a user detecting module configured for detecting whether there are multiple users; and
a user selecting module configured for selecting the user from the multiple users and locating the face of the user when multiple users are detected.

6. The electronic device of claim 5, wherein the user selecting module is configured for instructing the camera to recognize mouth gestures of each of the multiple users and selecting the user whose mouth gestures are the most active among the multiple users.

7. The electronic device of claim 1, further comprising a base member and a display member pivotally coupled to the base member, wherein the camera and the two microphones are arranged on the display member.

8. The electronic device of claim 7, wherein the camera and the two microphones are arranged in a line.

9. The electronic device of claim 8, wherein the two microphones are spaced and located on each side of the camera.

10. A voice recording method implemented in an electronic device, the method comprising:
imaginarily dividing space in front of a camera of the electronic device into a plurality of imaginary cubic areas;
associating each of the plurality of imaginary cubic areas with a delay parameter, the delay parameter representing a difference between time for sound to travel from an imaginary cubic area of the plurality of imaginary cubic areas to one of the two microphones and time for sound to travel from the imaginary cubic area to another one of the two microphones.
locating a face of a user;
determining an imaginary cubic area in which the face is located from the plurality of imaginary cubic areas;
calculating a wave beam pointing to the imaginary cubic area according to the delay parameter associated with the imaginary cubic area; and
recording voices within a range of the wave beam.

11. The voice recording method of claim 10, further comprising suppressing noises outside the range of the wave beam.

12. The voice recording method of claim 10, wherein the associating each of the plurality of imaginary cubic areas with a delay parameter comprises obtaining a delay parameter for each of the plurality of imaginary cubic areas according to the following formula:
$$Δ = \frac{\vert {D}_{1} - {D}_{2} \vert}{C} ,$$
wherein
Δ is the delay parameter,
D₁ is a distance between an imaginary cubic area of the plurality of imaginary cubic areas and a first one of the microphones,
D₂ is a distance between the imaginary cubic area and a second one of the microphones, and
C is the speed of sound.

13. The voice recording method of claim 12, further comprising:
monitoring whether a difference between voices recorded by the microphones exceeds a predetermined threshold; and
when the difference between voices recorded by the microphones exceeds the predetermined threshold, recalculating the wave beam pointing to the imaginary cubic area by applying a particle swarm optimization (PSO) algorithm.

14. The voice recording method of claim 12, further comprising:
detecting whether there are multiple users; and
when multiple users are detected, selecting the user from the multiple users and locating the face of the user.

15. The voice recording method of claim 13, further comprising:
recognizing mouth gestures of each of the multiple users; and
selecting the user whose mouth gestures are the most active among the multiple users and locating the face of the user.
